(19) United States
(12) Patent Application Publication
(10) Pub. No.: US 2006/0001743 A1
(43) Pub. Date: Jan. 5, 2006

(54) Tablet PC and digital camera arrangement

(76) Inventor: Chieh-Yin Lee, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/882,272

(22) Filed: Jul. 2, 2004

(51) Int. Cl. H04N 5/225

(52) U.S. Cl. 348/207.1

(57) ABSTRACT

A tablet PC and digital camera arrangement is described as having a tablet PC, a bracket formed integral with the housing of the tablet PC, two coupling plates respectively coupled to two upright supports of the bracket, a digital camera pivotally connected between the coupling plates at the bracket and electrically connected to the internal circuit of the tablet PC through a signal line, and two ornamental end caps fastened to the housing of the table PC around the two distal ends of the digital camera to kept the coupling plates and the bracket from sight.

### BACKGROUND OF THE INVENTION

1. Field of the Invention

The present invention relates generally to a tablet PC and more specifically to a tablet PC, which has a digital camera built in the housing thereof.

2. Description of the Related Art

A tablet PC is mobile compact personal computer convenient for carrying with the user. It combines a handwriting input system with a windows platform PC. Through the smart handwriting input system, a tablet PC is convenient for taking notes, recording something for further use, drawing pictures, etc., and the handwritings or pictures thus made can be stored as digital data.

Further, digital cameras have been intensively used as a substitute for conventional cameras due to their advantage of storing image data in a memory instead of the use of film. When the memory capacity in the camera is fully occupied, the storage data can be transmitted to a computer for image editing or printing.

The working principle of a digital camera is similar to conventional cameras with the exception of the use of an electronic image sensor and a memory as a substitute for film. The electronic image sensor picks up an image and converts the image into digital data for storing in the memory.

Some digital cameras can only take still photos. Other digital cameras can pick up motion pictures and record voices.

Following the fast development of information technology, computerization equipment has been gradually entering every company and family, and people have many chances for contact with computer peripheral apparatus. Nowadays, tablet PCs and digital cameras have become important peripheral apparatus in many companies and families. However, a tablet PC and a digital camera are two independent electronic devices. A tablet PC and a digital camera require a lot of storage space. Further, when using a digital camera with a tablet PC, a cable is necessary to transmit data from the digital camera to the tablet PC.

Therefore, it is desirable to provide a tablet PC and digital camera arrangement that eliminates the aforesaid drawbacks.

### SUMMARY OF THE INVENTION

The present invention has been accomplished under the circumstances in view. It is the main object of the present invention to provide a tablet PC with a digital camera built therein to save installation space. It is another object of the present invention to provide a tablet PC with a digital camera built therein for convenient use. It is still another object of the present invention to provide a tablet PC and a digital camera arrangement, which enables the digital camera to work with the tablet PC for quick image file access. To achieve these and other objects of the present invention, the tablet PC and digital camera arrangement comprises a tablet PC, and a digital camera pivotally fastened to the housing of the tablet PC and electrically connected to the internal circuit of the tablet PC.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 illustrates the outer appearance of the preferred embodiment of the present invention;

FIG. 2 is a perspective view showing the internal structure of the preferred embodiment of the present invention;

FIG. 3 is an exploded view of the preferred embodiment of the present invention; and

FIG. 4 is another exploded view of the preferred embodiment of the present invention;

### DETAILED DESCRIPTION OF THE INVENTION

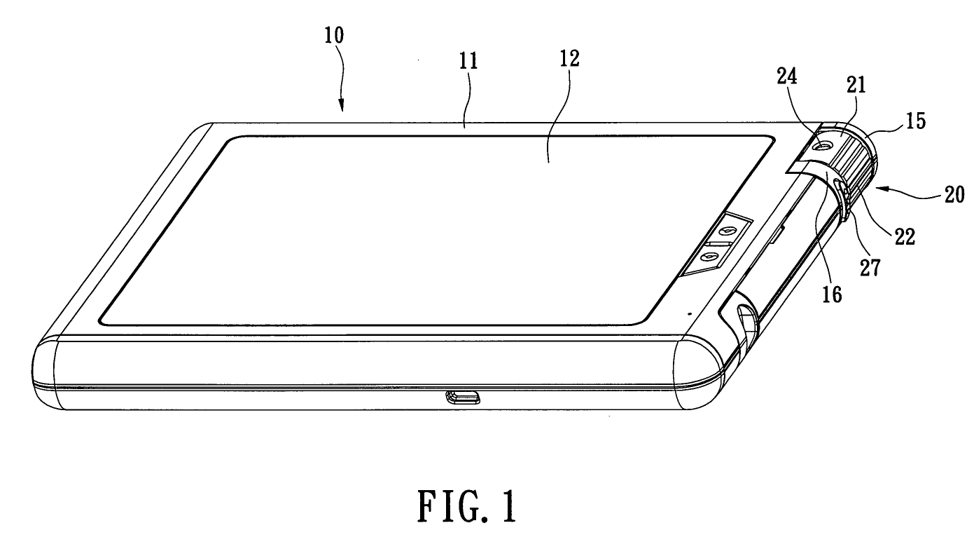

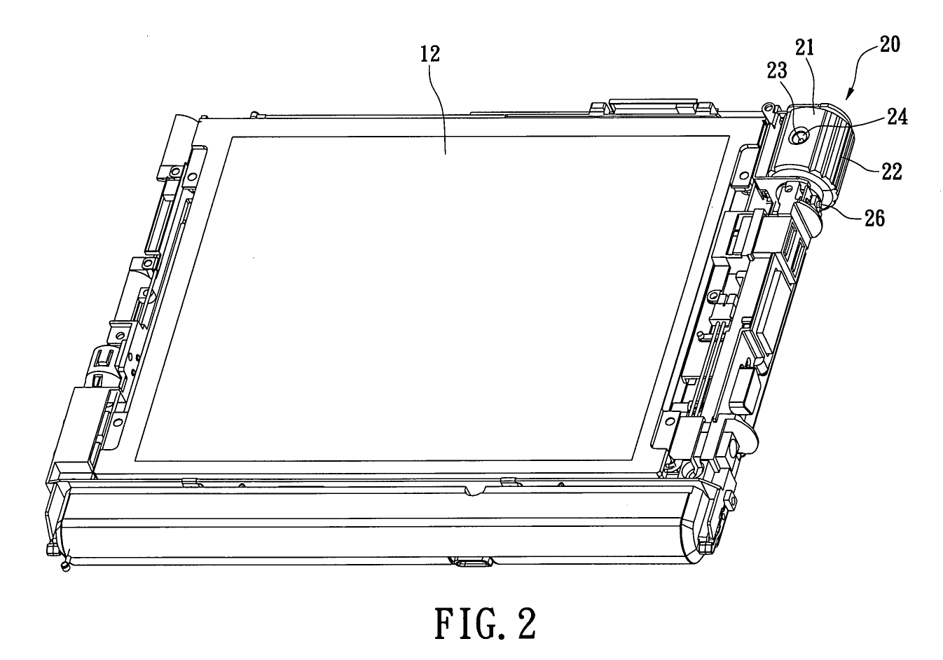

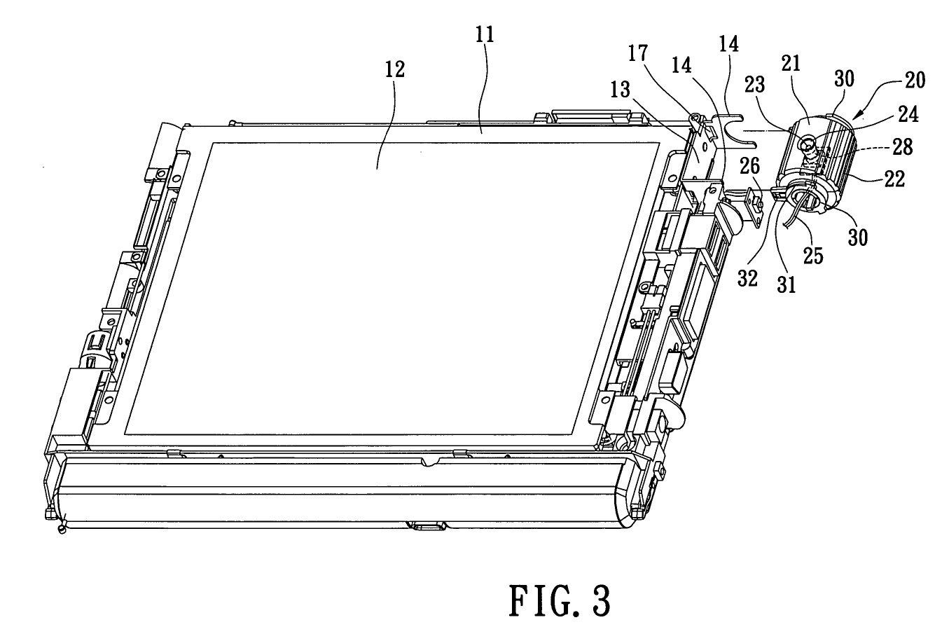

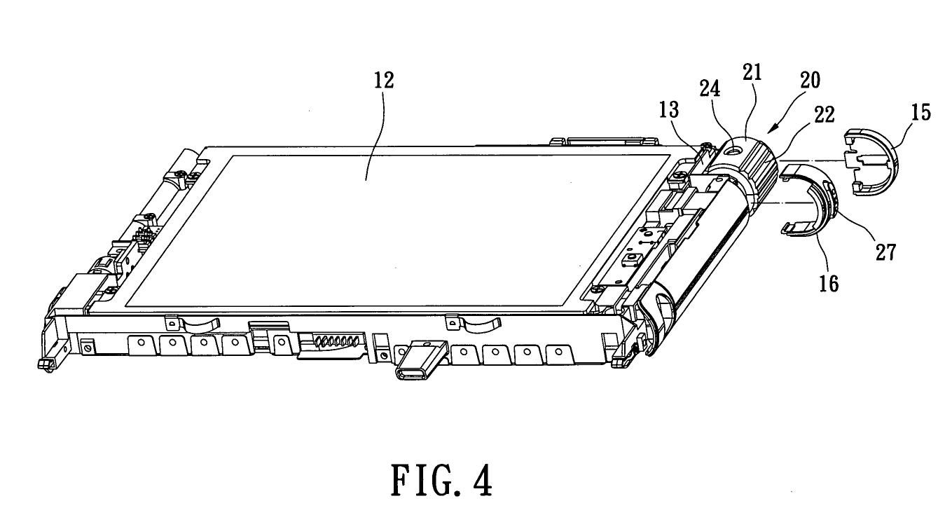

Referring to FIGS. 1-4, a tablet PC 10 is shown comprising a flat rectangular housing 11, a liquid crystal display panel 12 at the front side of the housing 11, and other devices including a battery pack, a data storage device (for example, hard disk drive), and a motherboard mounted inside the housing 11. The motherboard has installed therein a CPU, memories, chip sets, interface cards, etc. This structure of tablet PC 10 is substantially similar to that of conventional tablet PCs.

The main feature of the present invention is the arrangement of a digital camera 20 on the housing 11 of the tablet PC 10. The digital camera 20 comprises a hollow cylindrical casing 21. The casing 21 has embossed lines 22 on the periphery for positive positioning of the fingers to bias the digital camera 20 relative to the housing 11 of the tablet PC 10 when adjusting the shooting angle of the digital camera 20. The casing 21 of the digital camera 20 is not limited to the hollow cylindrical design. It may be made in any of a variety of shapes.

The digital camera 20 comprises a lens 23 mounted inside the casing 21, a through hole 24 formed in the casing 21 in line with the lens 23, an electronic image sensor 28 mounted inside the casing 21 behind the lens 23 and adapted to convert image signal obtained through the lens 23 into electric signal, a signal line 25 extended from the image sensor 28 to the internal circuit of the tablet PC 10 for transmitting signal from the image sensor 28 to the tablet PC 10, and a shutter 26 provided at one side of the housing 11 of the tablet PC 10 and electrically connected to the signal line 25. The image sensor 28 can be a CCD (charge coupled device) type image sensor or CMOS (complementary metal-oxide semiconductor) type image sensor.

The housing 11 of the tablet PC 10 comprises a bracket 13. The bracket 13 has two upright supports 14 arranged in parallel at two sides, and two retaining holes 17 respectively disposed adjacent to the upright supports 14. Two coupling plates 30 are fastened to the upright supports 14 of the bracket 13 to hold the digital camera 20. The digital, camera 20 is pivotally connected between the coupling plates 30. The coupling plates 30 each have a coupling hole 31 respectively coupled to the upright supports 14, and a retaining flange 32 respectively, fastened to the retaining holes 17 to firmly secure the coupling plates 30 to the bracket 13. By means of the coupling plates 30, the digital camera 20 is rotatably disposed at one side of the housing 11 of the tablet PC 20.

Further, an ornamental top end cap 15 and an ornamental bottom end cap 16 are respectively fastened to the housing 11 of the tablet PC 10 around the two distal ends of the casing 21 of the digital camera 20 and cover the upright supports 14. A shutter switch control button 27 is provided at the bottom end cap 16 corresponding to the shutter switch 26. Pressing the shutter switch control button 27 causes the shutter switch control button 27 to trigger the shutter switch 26.

As indicated above, the invention has the digital camera 20 directly built in the housing 11 of the tablet PC 10. Because the digital camera 20 is directly built in the housing 11 of the tablet PC 10, it is not necessary to install an external signal line and a connector for signal transmission from the digital camera 20 to the tablet PC 10. This compact design does not occupy much storage space. Further, image signals obtained from the digital camera 20 can be stored in memory means inside the tablet PC 10.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A tablet PC and digital camera arrangement comprising a tablet PC, comprising a housing, and a digital camera built in the housing of said digital camera.

2. The tablet PC and digital camera arrangement as claimed in claim 1, wherein said digital camera comprises a casing, a lens mounted inside said casing, a through hole formed in said casing in line with said lens, an electronic image sensor mounted inside said casing behind said lens and adapted to convert image signal obtained through said lens into electric signal, and a signal line extended from said image sensor to an internal circuit of said tablet PC for transmitting signal from said image sensor to said tablet PC.

3. The tablet PC and digital camera arrangement as claimed in claim 2, wherein said digital camera further comprises a shutter switch provided at one side of said housing of said tablet PC and electrically connected to said signal line.

4. The tablet PC and digital camera arrangement, as claimed in claim 3, wherein said digital camera further comprises an ornamental top end cap and an ornamental bottom end cap respectively fastened to the housing of said tablet PC around two distal ends of said casing, and a shutter switch control button provided on said ornamental bottom end cap for operation by the user to trigger said shutter switch.

5. The tablet PC and digital camera arrangement as claimed in claim 1, wherein said digital camera is fastened pivotally to the housing of said tablet PC.

6. The tablet PC and digital camera arrangement as claimed in claim 5, wherein said tablet PC comprises a bracket, said bracket comprises two upright supports and two retaining holes respectively disposed adjacent to said upright supports, and two coupling plates supporting said digital camera on said upright supports, said coupling plates each comprising a coupling hole respectively coupled to said upright supports and a retaining flange respectively fastened to said retaining holes, and wherein said digital camera is pivotally connected between said coupling plates.
